(19) United States
(12) Patent Application Publication
(10) Pub. No.: US 2017/0099020 A1
(43) Pub. Date: Apr. 6, 2017

(54) TORQUE CONTROL METHOD FOR AN ELECTRIC MOTOR

(71) Applicant: COMMISSARIAT A L'ENERGIE ATOMIQUE ET AUX ENERGIES ALTERNATIVES, PARIS (FR)

(72) Inventor: Neil ABROUG, Grenoble (FR)

(73) Assignee: COMMISSARIAT A L'ENERGIE ATOMIQUE ET AUX ENERGIES ALTERNATIVES, PARIS (FR)

(21) Appl. No.: 15/312,483

(22) PCT Filed: May 21, 2015
(86) PCT No.: PCT/EP2015/061286

§ 371 Date: Nov. 18, 2016

(30) Foreign Application Priority Data
May 21, 2014 (FR) 14 54580

(51) Int. Cl. H02P 7/06; H02P 29/40

(52) U.S. Cl. CPC H02P 7/06; H02P 29/40

(57) ABSTRACT

A method for controlling an electric motor that involving implementing a regulation loop regulating an induced current flowing in an induced circuit of a rotor of the motor, the regulation loop having, as the input signal, a current setpoint, as the return signal, a signal representative of the induced current, and as the output signal, a voltage control of the motor. The regulation loop includes a correction unit formed from an integral proportional corrector and a delay compensator.

The invention relates to the field of electric motor torque control.

### BACKGROUND OF THE INVENTION

The rotor of a direct current. motor bears conductors forming an armature circuit, said conductors being subjected to the magnetic influence of field system poles (permanent magnets or electromagnets) of the stator. The field system poles generate, on the conductors, a back-electromotive force that is proportional, with constant magnetic flux generated by the field system poles, to the speed of rotation of the rotor. The on-load back-electromotive force differs from the off-load back-electromotive force, because the current circulating on load in the conductors of the armature circuit modifies the distribution of the magnetic flux in the field system circuit of the stator. The torque (or current) control of a direct current motor entails implementing an effective current regulation loop to limit the effects of the electromotive force and the effects of nonlinearities disturbing the control (power supply, frictions, dead bands, etc.).

It is known practice, to reduce the effects of the back-electromotive force and of these nonlinearities, to implement a feedback regulation based on a corrector of proportional integral corrector (PI) type. This type of corrector does not make it possible to compensate all the effects of the back-electromotive force, particularly in the absence of load. This problem can, at first sight, seem unimportant, because the motors are generally associated with a predictable or known load. However, when a certain flexibility exists between the rotor of the motor and the load (for example in the case of an elastic series actuator motor), it may be necessary to ensure an effective compensation of the effects of the back-electromotive force without it being necessary to assume that a load is or is not in place.

One possible solution for solving this problem would be to implement, within the current regulation loop, a speed regulation with a proportional corrector. Thus, the authors of the document “Achieving efficient and stable communication through adaptation to changes in human arm impedance. LAMY. 2009 IEEE International Conference on Robotics and Automation” propose adding such a speed regulation to the current loop to confer a viscous behavior on an articulation of a robot arm that can be used in comanipulation. This solution presents at least two disadvantages: it reduces the bandwidth of the regulation loop, and it reduces controllability of the motor, that is to say the ability thereof to switch from an initial state to a set point state.

### SUBJECT OF THE INVENTION

The subject of the invention is a method for controlling an electric motor that makes it possible to reduce the effects of the back-electromotive force and of the nonlinearities disturbing the control without degrading the bandwidth or the controllability of the motor and of the actuator.

### SUMMARY OF THE INVENTION

In order to achieve this aim, there is proposed a method for controlling an electric motor comprising the implementation of a regulation loop for an induced current circulating in an armature circuit of a rotor of the motor, the regulation loop having, for input signal, a current set point, for return signal, a signal representative of the induced current, and, for output signal, a voltage control of the motor. According to the invention, the regulation loop comprises a corrector block formed by a proportional integral corrector and a lag compensator.

It is generally considered that an actuator comprising a direct current motor forms a system exhibiting a finite gain at low frequency, and therefore that a single corrector behaving as an integrator at low frequencies is sufficient in a current regulation loop used to control the direct current motor. This single corrector is chosen from competing candidates notably comprising the correctors of proportional integral connector and lag compensator type. Now, trials have shown that, when the rotor of the direct current motor is not blocked, the gain becomes nil or almost nil. The association of a proportional corrector and of a lag compensator then makes it possible to obtain a double integration behavior over certain frequency bands, and therefore very sharply reduce the effects of the back-electromotive force and of the nonlinearties. Furthermore, since the control method of the invention uses only one current regulation loop, it is not necessary to take into account, in the control, the mechanical behavior of the motor, which makes it possible to improve the bandwidth and does not degrade the controllability of the motor.

### BRIEF DESCRIPTION OF THE DRAWINGS

The invention will be better understood in light of the following description with reference to the figures of the attached. drawings in which:

FIG. 1 represents a block diagram illustrating the control method of the invention;

FIG. 2 is a graph illustrating the gain of a conventional proportional integral corrector;

FIG. 3 is a graph illustrating the gain of a conventional lag compensator;

FIG. 4 is a graph illustrating the gain of a corrector block of the control method of the invention;

FIG. 5 is a graph illustrating the gain of a sensitivity function of a regulation loop of the control method of the invention;

FIG. 6 is a graph illustrating the unit-step response (time response to an input step) of a complementary sensitivity function of the regulation loop of the control method of the invention.

### DETAILED DESCRIPTION OF THE INVENTION

Referring to FIG. 1, the control method of the invention is here intended to control a direct current motor 1 incorporated in an actuator 2 maneuvering a mobile segment of a robot arm used in comanipulation.

The control method of the invention is implemented by an electrical control circuit 3 connected to the direct current motor 1 and comprising a certain number of electronic components. These electronic components comprise in particular power supply components 4 intended to power, from an external power supply 5, the electronic components and the direct current motor 1, processing components 6 here comprising a microcontroller in which operations of the control method are programmed, and power components 7 (transistors, etc.) controlled by the processing components 6 to supply the direct current motor 1 with a power supply voltage and a power supply current.

The direct current motor 1 comprises a rotor 8 bearing conductors forming an armature circuit in which an induced current I circulates, and a stator 9 comprising permanent magnets generating a magnetic field originating from a force applied to the conductors of the armature circuit producing a mechanical torque tending to make the rotor 8 rotate. The direct current motor 1 is also provided with a current sensor 10 intended co measure the induced current I.

The control method of the invention aims co control the direct current motor 1 by regulating its torque, which amounts to regulating its current. The control method of the invention therefore comprises the implementation of a current regulation loop 11 intended to regulate the induced current I circulating in the armature circuit of the rotor 8 of the direct current motor I.

The current regulation loop 11 has, for input signal, a current set point Ic, for return signal, a signal representative of the induced current Ir, and, for output signal, a voltage control U of the direct current motor 1 applied to the rotor 8. The signal representative of the induced current Ir is measured by the current sensor 10 of the armature circuit. The automatic control loop 11 comprises a first subtractor 12 used to subtract from the current set point Ic the signal representative of the induced current Ir, so as to generate a current error εi.

The transformation of the voltage control U into the induced current I is performed by a system 13 comprising the power components 7 and the direct current motor 1, said system 13 here being modeled by a transfer function comprising a linear component and a nonlinear component.

The behavior of the linear component of the transfer function of the system 13 is governed by a first linear differential equation called electrical equation and by a second linear differential equation called mechanical equation.

The electrical equation is as follows:

$$L \cdot \frac{d I}{d t} = U - R \cdot I - kt \cdot \frac{d V}{d T} ,$$

and the mechanical equation is as follows:

$$J \cdot \frac{{d}^{2} V}{d {t}^{2}} = kt - f \cdot \frac{d V}{d T} ,$$

in which U is the voltage control of the motor applied to the rotor 8, V is the induced current, R is a resistance of the rotor 8, V is a speed of the rotor 8, L is an inductance of the rotor 8, kt is an electromechanical constant of the rotor 8, J is a moment of inertia of the rotor 8, and f is a viscous friction coefficient of the rotor 8.

The linear component of the transfer function of the system 13 can therefore he put in the following form:

$$\{ \begin{matrix}\dot{X} = A \cdot X + B \cdot U \\ Y = C \cdot X + DU\end{matrix} ,$$

in which U is the vector of the inputs, Y is the vector of the outputs, X is the state vector, and in which:

$$A = [ \begin{matrix}- 932.9 & - 575.7 & - 1486 & 300.2 & 361.2 \\ 575.7 & - 0.5805 & - 13.26 & 13.15 & 8.709 \\ 1486 & - 13.26 & - 336.7 & 657.6 & 281.5 \\ 300.2 & - 13.15 & - 657.6 & - 153.6 & - 336.5 \\ - 361.2 & 8.709 & 281.5 & 336.5 & - 909.4\end{matrix} ] ;$$

$$B = [ \begin{matrix}27.49 \\ - 0.6586 \\ - 11.42 \\ - 5.496 \\ 5.132\end{matrix} ]$$

$$C = [ \begin{matrix}27.49 & 0.6586 & 11.42 & - 5.496 & - 5.132\end{matrix} ] ;$$

$$D = [ 0.2032 ] .$$

Nonlinearities generated by the electrical control circuit 3 are introduced into this modeling.

The nonlinearities originate first of all from a saturation of the voltage control U of the direct current motor. This saturation originates from minimum and maximum limitations of the power supply voltage of the direct current motor 1, said minimum and maximum limitations resulting directly from the dimensioning of the power supply components 4 and of the external power supply 5. In the regulation loop 11, the saturation of the voltage control U is modeled by a saturator block 14 of unitary gain.

The nonlinearities then originate from “dead bands” due to so-called “bootstrap” capacitors included in the power components 7 of the electrical control circuit 3, said bootstrap capacitors provoking the cancelation of the set point, during a dead band time at the moment of a current set point inversion.

The behavior of the nonlinear component of the transfer function of the system 13 is, for its part, governed by the following equations:

$$\{ \begin{matrix}Ue ∈ ] - ∞ , - 19.8 ] ⇒ U = - 19.8 ; \\ Ue ∈ ] - 19.8 , - 0.9 ] ⇒ U = U = Ue + 0.9 ; \\ Ue ∈ ] - 0.9 , 0.8 ] ⇒ U = 0 ;\end{matrix} \\ Ue ∈ ] 0.8 , 19.8 ] ⇒ U = Ue - 0.8 ; \\ Ue ∈ ] 19.8 , ∞ ] ⇒ U = 19.8 ;$$

in which lie is the voltage controlled by the processing components 6 and U is, once again, he voltage control of the motor applied to the rotor 8.

The regulation loop 11 also comprises a controller 15 comprising a corrector block 16 and an anticipation filter 17. This controller 15 is designed to deliver a control of “H∞” type intended to minimize the effect of the disturbances at the output of the regulation loop 11, and to conform to the following constraints in the time domain:

$$\{ \begin{matrix}95 \% rise time \leq 1 ms ; \\ overshoot \leq 1 \% ; \\ static error \text{:} 0 \% ; \\ maximum disturbance \leq 40 \%\end{matrix} .$$

The corrector block 16 is formed by a proportional integral corrector 18 and a lag compensator 19.

The lag compensator 19 has a first order transfer function of which the gain at the low frequencies is greater than the gain at the high frequencies.

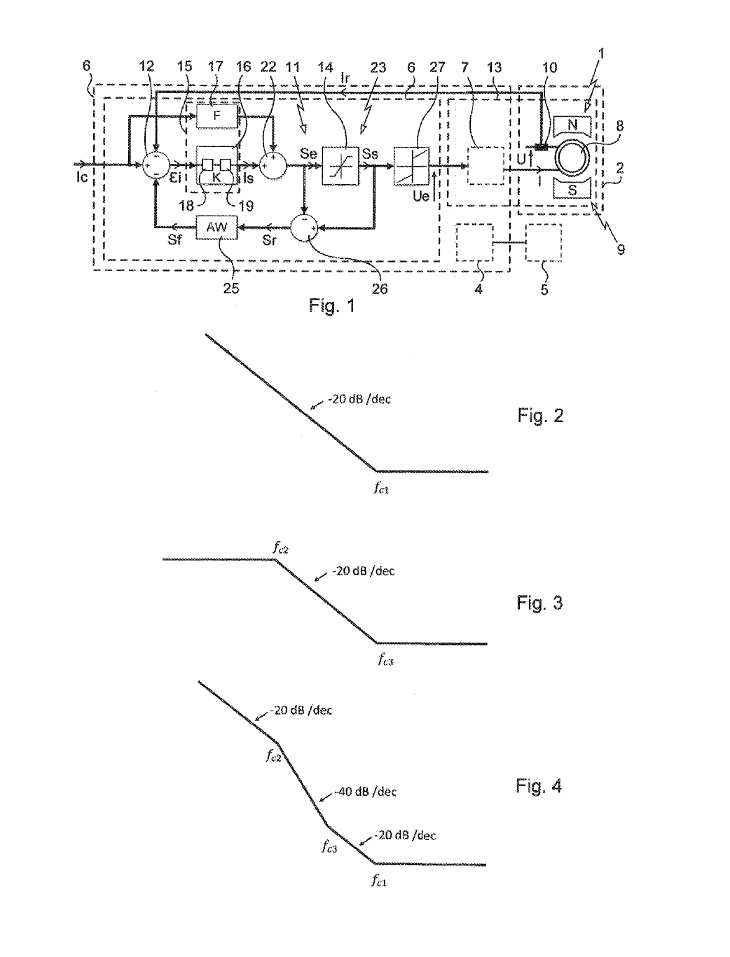

The benefit of constructing such a corrector block 16, formed by a proportional integral corrector 16 and a lag compensator 19 generally considered to be concurrent, can be seen in FIGS. 2 to 4.

Referring to FIG. 2, a proportional integral corrector exhibits an infinite gain at low frequency. This gain decreases by 20 dB per decade of frequency to a cutoff frequency fc1 from which the gain becomes constant.

Referring to FIG. 3, a lag compensator exhibits a finite gain at low frequency. From a cutoff frequency fc2, this gain decreases by 20 dB per decade of frequency to a second cutoff frequency fc3 from which the gain becomes constant again.

Referring to FIG. 4, the combined use of the proportional integral corrector 18 and of the lag compensator 19 makes it possible to obtain a corrector block. 16 exhibiting an infinite gain at low frequency. This gain decreases by 20 dB per decade of frequency to fc2, by 40 dB per decade of frequency between fc2 and fc3, by 20 dB per decade of frequency from fc3 to fc1 and becomes constant from fc1. The behavior of the corrector block 16 is therefore that of a double integrator between fc2 and fc3.

The transfer function K of the corrector block 16 is here:

$$K = ( 1.87 + \frac{3.5 e + 0.3}{s} ) \cdot ( \frac{s + 95.46}{s + 5.142} ) .$$

The corrector block 16 is linked to the first subtractor 12 and has the current error εi for input signal.

The anticipation filter 17 of the controller 15 is, for its part, intended. to add to an output signal Is of the corrector block 16 the input signal of the automatic control loop, or current set point Ic, exhibiting a certain delay and multiplied. by a certain gain. To this end, the regulation loop is provided with a summer 22. The anticipation filter 17 is a second order filter exhibiting the following transfer function F:

$$F = \frac{- 0.13762 \cdot ( {s}^{2} + 7192 \cdot s + 1.932 {e}^{7} )}{{s}^{2} + 1140 s + 5.909 {e}^{6} )} .$$

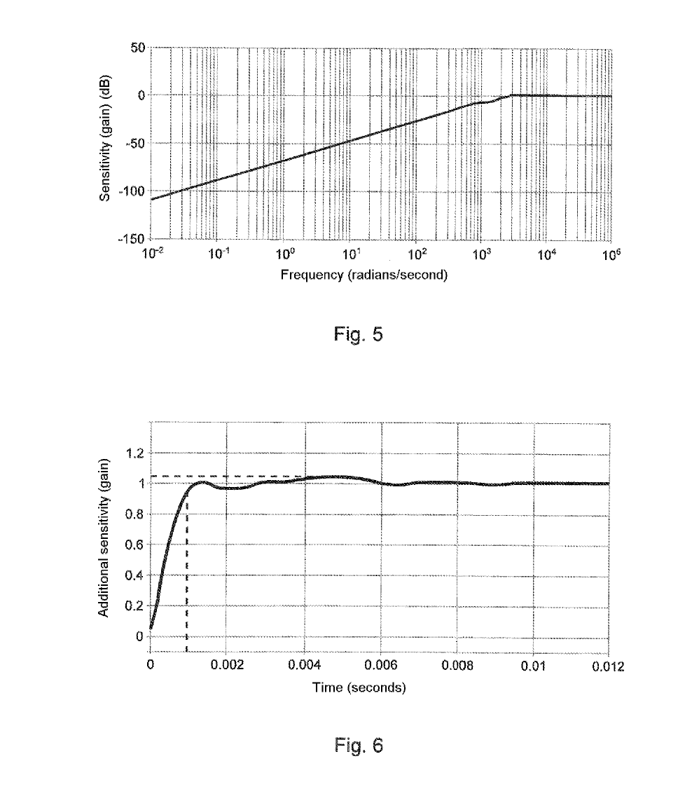

FIG. 5 represents the gain of the sensitivity function at the output of the controller 15, which describes the sensitivity of the output of the controller 15 to the disturbances. FIG. 6 represents the gain of the complementary sensitivity function which determines the relationship between the output of the controller 15 and the current set point Ic, in the case of a stepwise current set point Ic.

The regulation loop 11 also comprises an anti-windup device 23 intended to contain the effects of the saturation of the voltage control U, by keeping the value of an input signal Se of the saturator block 14 close to that of an output signal Ss of the saturator block 14 and thus avoid rendering the regulation loop 11 unstable. The anti-windup device 23 comprises a first order filter 25 and a second subtractor 26 intended to subtract the input signal Se of the saturator block 14 from the output signal Ss of the saturator block 14. An output signal Sr of the second subtractor 26 is applied to the input of the first order filter 25. An output signal Sf of the first order filter 25 is subtracted from the input signal of the automatic control loop, or current set point Ic, by the first subtractor 12.

The transfer function of the first order filter 25 is as follows:

$$AW = \frac{0.85971 ( s + 2569 )}{s + 4353} .$$

The automatic control loop 11 finally comprises a dead band compensator 27, of friction compensator type, connected to the output of the saturator block 14. The dead band compensator is intended to compensate harmonic distortions introduced by the dead band.

The invention is not limited to the particular implementation which has just been described, but, quite the contrary, covers any variant falling within the scope of the invention as defined by the claims.

Although the control method of the invention has been applied to a direct current motor, the method can also be used to drive another type of electric motor, notably a brushless synchronous electric motor. In effect, by a mathematical transformation (Clarke and Park transformation), the control of a brushless synchronous electric motor can be reduced conceptually to the control of two direct current motors: the expression vector control applies.

1. A method for controlling an electric motor comprising the implementation of a regulation loop for an induced current circulating in an armature circuit of a rotor of the motor, the regulation loop having, for input signal, a current set point, for return signal, a signal representative of the induced current, and, for output signal, a voltage control of the motor, the method being characterized in that the regulation loop comprises a corrector block formed by a proportional integral corrector and a lag compensator.

2. The control method as claimed in claim 1, in which the lag compensator has a first order transfer function of which the gain at the low frequencies is greater than the gain at the high frequencies.

3. The control method as claimed in claim 1, in which the regulation loop further comprises an anticipation filter intended to add to an output signal of the corrector block the input signal of the regulation loop exhibiting a certain delay and multiplied by a certain gain.

4. The control method as claimed in claim 3, in which the anticipation filter is a second order filter.

5. The control method as claimed in claim 1, in which the regulation loop comprises an anti-windup device intended to minimize the effects of a saturation of the voltage control.

6. The control method as claimed in claim 5, in which the anti-windup device comprises a first order filter.
